(19) United States
(12) Patent Application Publication
(10) Pub. No.: US 2026/0308428 A1
(43) Pub. Date: Oct. 8, 2026

(54) ADHESIVE INCLUDING TACKIFIED ELASTOMER COMPOSITION IN LIQUID VEHICLE AND RELATED PROCESSES

(71) Applicant: 3M INNOVATIVE PROPERTIES COMPANY, St. Paul, MN (US)

(72) Inventors: Ryan K. McKenney, Roseville, MN (US); Christopher R. Johnson, Eagan, MN (US); Gregg A. Patnode, Woodbury, MN (US); Allyson V. Grym, Eagan, MN (US); DanLi Wang, North Oaks, MN (US)

(21) Appl. No.: 19/483,445

(22) PCT Filed: May 13, 2024
(86) PCT No.: PCT/US2024/029084

§ 371 Date: Nov. 11, 2025

Related U.S. Application Data
(60) Provisional application No. 63/465,687, filed on May 11, 2023.
(60) Provisional application No. 63/641,261, filed on May 1, 2024.

(51) Int. Cl. C09J 145/00; C09J 5/00

(52) U.S. Cl. CPC C09J 145/00; C09J 5/00; C09J 2431/00; C09J 2453/00; C09J 2471/00

(57) ABSTRACT

An adhesive includes a tackified elastomer composition at least one of dissolved or dispersed in a liquid vehicle. The tackified elastomer composition includes a block copolymer comprising at least one polystyrene end block, a terpene resin, and a polyphenylene ether resin. A process of making a bonded article including spraying the adhesive and the use of the adhesive as a spray adhesive are also disclosed.

### CROSS-REFERENCE TO RELATED APPLICATION

This application claims priority to U.S. Provisional Application Nos. 63/465,687, filed May 11, 2023, and 63/641,261, filed May 1, 2024, the disclosures of which are incorporated by reference in their entirety herein.

### BACKGROUND

Styrene-conjugated diene block copolymers have been formulated to produce adhesive compositions. For example, U.S. Pat. No. 3,239,478 (Harlan), shows combinations of these block copolymers with tackifying resins and paraffinic extending oils to produce various types of adhesives. However, one of the limitations of these adhesive compositions is their relatively low service temperatures. U.S. SIR H1387 (Hansen et al.) and U.S. Pat. No. 4,104,323 (Hansen) propose using polyphenylene ether melt-blended with other endblock compatible resins to improve the performance of styrene-conjugated diene block copolymer-based hot-melt processed adhesives at relatively higher temperatures.

U.S. Pat. Appl. Pub. No. 2021/0130662 (Chastek et al.) describes melt-processible pressure-sensitive adhesives that include a block copolymer, polyphenylene ether, and a hydrocarbon tackifier, and require a (meth)acrylic functional additive having glass transition temperature in a range from 50° C. to 160° C. Chastek et al. states that pressure-sensitive adhesives (“PSAs”) are adhesives that are normally tacky at room temperature and can be adhered to a substrate surface by application of light pressure and that no solvent, water, or heat is needed to activate the adhesive.

### SUMMARY

In one aspect, the present disclosure provides an adhesive that includes a tackified elastomer composition at least one of dissolved or dispersed in a liquid vehicle. The tackified elastomer composition includes a block copolymer comprising at least one polystyrene end block, a terpene resin, and a polyphenylene ether resin.

In another aspect, the present disclosure provides a process of making a bonded article including a first substrate and a second substrate. The process includes spraying the adhesive on at least one of the first substrate or the second substrate and adhering the first substrate and the second substrate using the adhesive. In some embodiments, the process further includes evaporating a portion of the liquid vehicle before adhering the first substrate and the second substrate.

In another aspect, the present disclosure provides a use of the adhesive as a spray adhesive.

In another aspect, the present disclosure provides a tape comprising and/or made from the adhesive disposed on a tape backing.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The term “polystyrene” as used herein includes polymers and copolymers of substituted styrene monomers and/or unsubstituted styrene.

The phrase “based on the total weight of the tackified elastomer composition” does not include the liquid vehicle in the adhesive composition of the present disclosure.

By “dispersed”, it is meant a heterogeneous mixture of the tackified elastomer composition as discrete particles or droplets in the liquid vehicle. “Dispersed” does not encompass “dissolved”.

The term “elastomer” refers to a molecule having a structure which essentially includes the multiple repetition of units derived, actually or conceptually, from monomers of low relative molecular mass. The term “elastomer” refers to a type of polymer with elastic character.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### DETAILED DESCRIPTION

For elastomer compositions including a block copolymer comprising one or more polystyrene end blocks tackified with certain terpene resins, especially aromatic-modified terpene resins, the present inventors have observed incompatibility between the block copolymer and the terpene resin, which leads to phase separation of the tackifier from the rubber. Compatibility between the block copolymer and terpene resin tackifier is important for achieving good adhesive performance. Such compatibility becomes more important in compositions having relatively higher amounts of tackifier, for example, having a weight ratio of the terpene resin to the block copolymer being greater than 1:1 or at least 1.5:1, 1.6:1, 1.7:1, or 1.9:1. Compatibility in a tackified elastomer composition including a block copolymer and a terpene resin can be evaluated using rheology. Incompatibility can be evidenced in rheological curves by broader tan delta peaks with lower tan delta peak heights and secondary tan delta peaks or increasing tan delta values at higher temperatures. Secondary tan delta peaks may be attributed to excess tackifier that is not fully incorporated into the elastomer.

The present disclosure provides tackified elastomer compositions with improved compatibility. The addition of a polyphenylene ether resin changes the rheology curves and unexpectedly decreases the high temperature tan delta values. As shown in a comparison of Control Example A and Examples 1 to 5, the addition of a polyphenylene ether resin results in a decreased tan delta value at 120° C. and provides an enhancement in adhesion performance and high-temperature adhesion performance. Similarly, as shown in a comparison of Control Example E and Examples 13 to 17, the addition of a polyphenylene ether resin results in a decreased tan delta value at 100° C. and provides an enhancement in adhesion performance and high-temperature adhesion performance. Such benefits have been observed in various adhesive compositions having different levels of tackifiers and/or different types of block copolymers. Also, as shown in the Examples below, tackified elastomer compositions including a block copolymer at least one polystyrene end block, a terpene resin, and a polyphenylene ether resin provided the same rheology curve after aging at 120° F. (49° C.) for approximately 2 weeks. These results demonstrate the stability (e.g., no phase separation) of the tackified elastomer composition.

The tackified elastomer composition in the adhesive of the present disclosure includes a block copolymer comprising at least one polystyrene end block. The tackified elastomer composition can include a single block copolymer or a mixture of two or more block copolymers. In some embodiments, at least one block copolymer in the tackified elastomer composition is a block copolymer comprising a midblock and two or more polystyrene end blocks. The midblock is generally a rubbery block (or low-Tg block), and the polystyrene end blocks are sometimes referred to as glassy blocks or high-Tg blocks.

While the present disclosure is not to be bound by theory, it is believed that at the service temperature of the adhesive, the block copolymer microphase separates into ordered nanoscale domains that include rubbery block domains and glassy block domains. When microphase separated, these copolymers form elastic, dimensionally stable solids that display significant shear strength. Unlike chemically crosslinked rubbers, the block copolymers are capable of being reversibly melted and re-solidified; thus, they are known as thermoplastic elastomers.

In some embodiments, the block copolymer is a linear block copolymer of general formula (S—R)ₘ—S where each S is independently a polystyrene block, each R is independently a rubbery block, and m is a value of at least 1. Variable m can be from 1 to 10, 1 to 5, 1 to 3, or in some embodiments, less than, equal to, or greater than 1, 2, 3, 4, 5, 6, 7, 8, 9, or 10. In some embodiments, the linear block copolymer is a triblock copolymer wherein m is 1 and can also be represented by formula S—R—S.

In some embodiments, the block copolymer can be a star (also known as a radial or multi-arm) block copolymer of general formula (S—R)ₙ—Y where each R and S are independently the same as defined above, n is an integer equal to at least 3, and Y is the residue of a multifunctional coupling agent used in the formation of the star block copolymer. The variable n represents the number of arms in the star block copolymer and can be from 3 to 10, from 3 to 8, from 3 to 6, or in some embodiments, less than, equal to, or greater than 3, 4, 5, 6, 7, 8, 9, or 10.

In the block copolymer, including any of those described above, the polystyrene blocks can have the same or different molecular weights. In some embodiments, each polystyrene block independently has a weight average molecular weight of 4,000 to 50,000 grams per mole. Similarly, if there is more than one midblock (e.g., rubbery block), the midblocks can have the same or different molecular weights. In some embodiments, each midblock independently has a weight average molecular weight of 5,000 to 500,000 grams per mole.

Generally, each midblock has a glass transition temperature (T_{g}) that is less than ambient temperature. For example, the glass transition temperature can be less than 20° C., less than 0° C., less than −10° C., or less than −20° C., less than −40° C., less than −60° C., or in some embodiments, less than, equal to, or greater than −60° C., −55° C., −50° C., −45° C., −40° C., −35° C., −30° C., −25° C., −20° C., −15° C., −10° C., −5° C., 0° C., 5° C., 10° C., 15° C., or 20° C. The glass transition temperature can be determined using conventional methods known in the art, including Differential Scanning Calorimetry or Dynamic Mechanical Analysis.

In some embodiments, each midblock in the block copolymer is the polymerized product of a conjugated diene, a hydrogenated derivative of a polymerized conjugated diene, or a combination thereof. The conjugated diene often contains 4 to 12 carbon atoms. Examples of useful conjugated dienes include butadiene, isoprene, 2-ethylbutadiene, 1-phenylbutadiene, 1,3-pentadiene, 1,3-hexadiene, 2,3-dimethyl-1,3-butadiene, 3-ethyl-1,3-hexadiene and combinations thereof. Each midblock can be a homopolymer or copolymer. In some embodiments, the midblock comprises at least one of poly(butadiene), poly(isoprene), poly(2-ethylbutadiene), poly(1-phenylbutadiene), poly(1,3-pentadiene), poly(1,3-hexadiene), poly(2,3-dimethyl-1,3-butadiene), poly(3-ethyl-1,3-hexadiene), poly(ethylene/propylene), poly(ethylene/butylene), or poly(isoprene/butadiene). In some embodiments, the midblock comprises at least one of polybutadiene, polyisoprene, poly(isoprene/butadiene), poly(ethylene/butylene), poly(ethylene/propylene), or polyisobutylene.

The glass transition temperature of each polystyrene block is generally at least 50° C., at least 60° C., at least 70° C., at least 80° C., at least 90° C., at least 100° C., or in some embodiments, less than, equal to, or greater than 50° C., 55° C., 60° C., 65° C., 70° C., 75° C., 80° C., 85° C., 90° C., 95° C., or 100° C.

Styrene monomers useful for making the polystyrene end blocks may be unsubstituted or substituted. Useful styrene monomers at least 8 carbon atoms and in some embodiments contain at least 10 carbon atoms or at least 12 carbon atoms and up to 18 carbon atoms, up to 16 carbon atoms, or up to 14 carbon atoms. Examples of suitable styrene monomers include styrene, vinyltoluene (e.g., 2, 3, or 4-vinyltoluene), alpha-methyl styrene, 2,4-dimethyl styrene, ethyl styrene, 2,4-diethyl styrene, 3,5-diethyl styrene, alpha-2-methyl styrene, 4-tert-butyl styrene, 4-isopropyl styrene, and combinations thereof. Each polystyrene block can be a homopolymer or a copolymer. In some embodiments, the polystyrene end blocks each comprise at least one of unsubstituted polystyrene, poly(vinyltoluene), poly(alpha-methylstyrene), poly(2,4-dimethylstyrene), poly(ethylstyrene), poly(2,4-diethylstyrene), poly(3,5-diethylstyrene), poly(4-tert-butylstyrene), or poly(4-isopropyl styrene). In some embodiments, the polystyrene end blocks each comprise unsubstituted polystyrene. In some embodiments in which one or more polystyrene end blocks comprises a copolymer, at least 50 weight percent (wt %) (in some embodiments, at least 60 wt %, at least 70 wt %, at least 80 wt %, at least 90 wt %, at least 95 wt %, at least 98 wt % or at least 99 wt %) of the monomeric units are derived from styrene.

Polystyrene blocks including the polystyrene end blocks can represent from 5 to 50 percent by weight of the block copolymer. With such an amount of polystyrene in the block copolymer, a useful balance of cohesive strength and modulus may be achieved. The block copolymer can have a polystyrene block content of from 7 wt % to 40 wt %, 9 wt % to 33 wt %, 13 wt % to 25 wt %, or in some embodiments, less than, equal to, or greater than 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 27 wt %, 30 wt %, 32 wt %, 35 wt %, 37 wt %, or 40 wt %, based on the total weight of the block copolymer.

In addition to the polystyrene blocks and the midblocks, star block copolymers include a residue of a multifunctional coupling agent Y. The coupling agent often has multiple carbon-carbon double bonds, carbon-carbon triple bonds, or other groups that can react with carbanions of a living polymer that may be used to form the star block copolymers. The multifunctional coupling agents can be aliphatic, aromatic, heterocyclic, or a combination thereof. Examples of suitable coupling agents include polyvinyl acetylene, diacetylene, di(meth)acrylates (e.g., ethylene dimethacrylate), divinyl benzene, divinyl pyridine, and divinyl thiophene. Other useful coupling agents include multi-functional silyl halide (e.g., tetrafunctional silyl halide), polyepoxides, polyisocyanates, polyketones, polyanhydrides, polyalkenyls, and dicarboxylic acid esters.

The weight average molecular weight of the block copolymer is often not more than 1,200,000 grams per mole (g/mol). In some embodiments, the weight average molecular weight is not more than 1,050,000 g/mol, 900,000 g/mol, 800,000 g/mol, 600,000 g/mol, or 500,000 g/mol. In some embodiments, the weight average molecular weight of the block copolymer is at least 75,000 g/mol, at least 100,000 g/mol, at least 200,000 g/mol, at least 300,000 g/mol, or at least 400,000 g/mol. The weight average molecular weight of the block copolymer can be from 75,000 g/mol to 1,200,000 g/mol, from 100,000 to 1,000,000 g/mol, from 100,000 to 900,000 g/mol, or from 100,000 to 500,000 g/mol.

In some embodiments, the tackified elastomer composition includes a diblock copolymer. The diblock copolymer generally has a single polystyrene block and a single rubbery block and can be represented here by the chemical structure S—R, wherein S and R are as defined above in any of their embodiments.

The polystyrene block content in the diblock copolymer can be from 10 wt % to 50 wt %, from 10 wt % to 40 wt %, from 15 wt % to 50 wt %, from 15 wt % to 40 wt %, from 20 wt % to 50 wt %, from 20 wt % to 40 wt %, or in some embodiments, less than, equal to, or greater than 10 wt %, 12 wt %, 15 wt %, 17 wt %, 20 wt %, 22 wt %, 25 wt %, 27 wt %, 30 wt %, 32 wt %, 35 wt %, 37 wt %, or 40 wt % relative to the overall weight of the diblock copolymer. The weight average molecular weight of the diblock copolymer can be from 75,000 g/mol to 250,000 g/mol, from 100,000 g/mol to 250,000 g/mol, from 125,000 g/mol to 250,000 g/mol, or from 125,000 g/mol to 200,000 g/mol.

In some embodiments, the block copolymer comprises at least one of a polystyrene-containing diblock copolymer, a polystyrene-containing triblock copolymer, or a polystyrene-containing star block copolymer, wherein the polystyrene-containing diblock copolymer, the polystyrene-containing triblock copolymer, and the polystyrene-containing star block copolymer each independently comprise a block of at least one of polyisoprene, polybutadiene, poly(ethylene/propylene), poly(ethylene/butylene), or polyisobutylene. In some embodiments, the block copolymer comprises at least one of a polystyrene-containing diblock copolymer, a polystyrene-containing triblock copolymer, or a polystyrene-containing star block copolymer, wherein the polystyrene-containing diblock copolymer, the polystyrene-containing triblock copolymer, and the polystyrene-containing star block copolymer each independently comprise a block of at least one of polyisoprene or polybutadiene. In some embodiments, the block copolymer comprises at least one of a styrene-isoprene-styrene triblock copolymer or a styrene-butadiene-styrene triblock copolymer. In some embodiments, the block copolymer comprises a styrene-butadiene-styrene triblock copolymer and a styrene-isoprene-styrene triblock copolymer. In some embodiments, the block copolymer comprises a styrene-butadiene-styrene triblock copolymer and a styrene-isoprene-styrene triblock copolymer in a ratio of at least 1:1, 2:1, 3:1, 4:1, 5:1, or 10:1 and up to 25:1, 20:1, 10:1, or 5:1. In some embodiments, the block copolymer comprises a diblock copolymer and a triblock copolymer, including those described in any of the aforementioned embodiments, wherein the diblock copolymer is present in an amount of from 10 wt % to 90 wt %, from 20 wt % to 90 wt %, or from 50 wt % to 85 wt % based on the total weight of the triblock copolymer and the diblock copolymer.

The block copolymer can be present in any suitable amount in the tackified elastomer composition. In some embodiments, the block copolymer is present in amount of from 20 wt % to 60 wt %, from 20 wt % to 50 wt %, from 20 wt % to 40 wt %, or less than 50 wt %, based on the total weight of the tackified elastomer composition.

Suitable materials for use as the block copolymer alone or in combination are commercially available, for example, under the trade designation KRATON (e.g., KRATON D1161P, D1118, D1119, and A1535) from Kraton Performance Polymers (Houston, TX, USA), under the trade designation SOLPRENE (e.g., SOLPRENE S-1205) from Dynasol (Houston, TX, USA), under the trade designation QUINTAC from Zeon Chemicals (Louisville, KY, USA), and under the trade designations VECTOR and TAIPOL from TSRC Corporation (New Orleans, LA, USA).

The tackified elastomer composition in the adhesive of the present disclosure includes a terpene resin. Terpene resins useful in the tackified elastomer composition include polyterpene homopolymers, copolymers of more than one terpene monomer, copolymers of one or more terpene monomers and one or more additional monomers, and hydrogenated products of any of these polymers. Examples of terpene monomers useful for any of these terpene resins include α-pinene, β-pinene, dipentene, and limonene. Catalyzed cationic and anionic polymerizations of terpenes are known. Monomers suitable for copolymerization with terpenes include styrene, alpha-methylstyrene, vinyltoluene, and any of the other substituted styrene monomers listed above. Copolymers of terpenes with styrene and substituted styrene monomers are referred to herein as aromatic-modified terpene resins. Further monomers suitable for copolymerization with terpenes include phenols such as phenol, cresol, and bisphenol. Copolymers of terpenes with phenolic monomers are referred to herein as terpene phenolic resins. In some embodiments, the terpene resin is an aromatic-modified terpene resin. In some embodiments, the aromatic-modified terpene is not a terpene-phenolic resin. In some embodiments, the terpene resin is a copolymer of a terpene and at least one of styrene or a substituted styrene.

Terpene resins including any of those described above may have a number average molecular weight in a range from 600 g/mol to 10000 g/mol and a softening point of 60° C. to 150° C. In some embodiments, the number average molecular weight of the terpene resin is up to about 5000 g/mol, 4000 g/mol, 2500 g/mol, 2000 g/mol, or 1500 g/mol. In some embodiments, the number average molecular weight is in the range of 200 g/mol to 5000 g/mol, in the range of 200 to 4000 g/mol, in the range of 200 to 2000 g/mol, or in the range of 200 to 1500 g/mol. Number average molecular weights are determined using gel permeation chromatography according to methods known to a person skilled in the art. In some embodiments, the terpene resin has a softening point of at least 70° C., at least 80° C., at least 90° C., at least 100° C., or at least 110° C. as measured using a ring and ball apparatus.

Examples of suitable terpene resins and hydrogenated terpene resins include those available under the trade designation CLEARON (e.g., CLEARON P150 and P135) from Yasuhara Chemical Company, Ltd. in Hiroshima, Japan. Examples of suitable terpene phenolic resins include those available under the trade designation YS POLYSTER (e.g., POLYSTER T115, T160, T130, S145, and G150) from Yasuhara Chemical Company, Ltd. Examples of suitable aromatic-modified terpene resins include those available under the trade designations “YS RESIN TO” and “YS RESIN TR” from Yasuhara Chemical Co., Ltd.

The terpene resin can be present in any suitable amount in the tackified elastomer composition. In some embodiments, the terpene resin is present in amount of from 40 wt % to 75 wt %, from 40 wt % to 70 wt %, from 45 wt % to 65 wt %, greater than 50 wt % or greater than 45 wt %, based on the total weight of the tackified elastomer composition. In some embodiments, a weight ratio of the terpene resin to the block copolymer is greater than 1:1. In some embodiments, the weight ratio of the terpene resin to the block copolymer is at least 1.5:1, 1.6:1, 1.7:1, 1.9:1, and may be up to 2:1, 2.5:1, or more.

As taught in U.S. Pat. Appl. Pub. No. 2021/0130662 (Chastek et al.), if the amount of a tackifier such as a terpene is greater than 50% by weight relative to the overall weight of the adhesive composition, the level of tackifier may be too high, and the resulting composition may not be a pressure-sensitive adhesive. Thus, 2021/0130662 (Chastek et al.) would be understood to discourage a weight ratio of the terpene resin to the block copolymer being greater than 1:1, in some embodiments, at least 1.5:1, 1.6:1, 1.7:1, 1.9:1, and may be up to 2:1, 2.5:1, or more.

PSAs are generally known to possess the following desirable properties: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. The Dahlquist criterion is commonly used to describe such behavior of PSAs. The Dahlquist criterion for a PSA suggests that the shear Storage Modulus G′ should not exceed 0.3 megapascal (MPa) at 25° C. applying an oscillatory strain at 1 hertz (Hz) within the linear viscoelastic region of the PSA. If the Dahlquist criterion is exceeded, PSAs usually lose their tackiness, and adhesion build-up no longer takes place properly. Thus, the Dahlquist criterion represents an upper limit of the storage modulus for obtaining PSA properties. In some embodiments, the present disclosure provides adhesive films that exceed the Dahlquist criterion (e.g., greater than 0.3 MPa at 25° C.), but in combination with the liquid vehicle, provide excellent adhesive properties, in some embodiments, pressure-sensitive adhesive properties.

The tackified elastomer composition in the adhesive of the present disclosure comprises a polyphenylene ether resin, which also may be referred to as a polyphenylene oxide resin. A combination of two or more polyphenylene ether resins may be useful in the tackified elastomer composition. In some embodiments, the polyphenylene ether resin contains the repeating unit shown in Formula I, below,

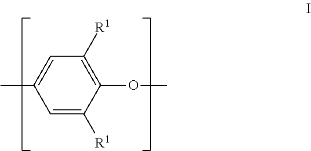

and isomers thereof, wherein each R¹ is independently hydrogen, halogen, alkyl, haloalkyl having at least two carbon atoms between the halogen atom and the phenyl nucleus, alkoxy, and haloalkoxy having at least two carbon atoms between the halogen atoms and phenyl nucleus. In some embodiments, each R¹ is a methyl group, and the polyphenylene ether is poly(2,6-dimethyl-1,4-phenylene oxide). In some embodiments, each R¹ is hydrogen (i.e., poly(para-phenylene oxide). In some embodiments, contrary to what is shown in Formula I, the linkages are not at para positions.

In some embodiments, the polyphenylene ether resin has a number average molecular weight (Mw) of from 300 g/mol to 25,000 g/mol, from 300 g/mol to 10,000 g/mol, from 1,000 to 8,000 g/mol, or in some embodiments, less than, equal to, or greater than 1,000 g/mol, 1,200 g/mol, 1,500 g/mol, 1,700 g/mol, 2,000 g/mol, 2,500 g/mol, 3,000 g/mol, 3,500 g/mol, 4,000 g/mol, 4,500 g/mol, 5,000 g/mol, 5,500 g/mol, 6,000 g/mol, 6,500 g/mol, 7,000 g/mol, 7,500 g/mol, or 8,000 g/mol, 10,000 g/mol, 25,000 g/mol, or 50,000 g/mol. Number average molecular weights are determined using gel permeation chromatography according to methods known to a person skilled in the art.

Polyphenylene ether resins can be made by any known method. Suitable methods of preparation are described in U.S. Pat. No. 3,306,874 (Hay); U.S. Pat. No. 3,306,875 (Hay); U.S. Pat. No. 3,257,357 (Stamatoff); and U.S. Pat. No. 3,257,358 (Stamatoff). Examples of suitable polyphenylene ether resins are commercially available under the trade designations “NORYL SA90” and “NORYL SA120” from Sabic, Houston, TX, and under the trade designation “STARAIR” from China Bluestar International Chemical Co., Ltd., Beijing, China.

In some embodiments, the polyphenylene ether resin is present in the tackified elastomer composition in an amount from 1 wt % to 20 wt %, from 2 wt % to 18 wt %, or from 3 wt % to 16 wt %, based on the total weight of the tackified elastomer composition. In some embodiments, a weight ratio of the block copolymer to the polyphenylene ether is in a range from 3:1 to 25:1, from 3:1 to 15:1, or from 3:1 to 10:1.

While other aromatic tackifying resins may be useful in the tackified elastomer composition, in some embodiments, the tackified elastomer composition does not include a significant amount of other aromatic resins reported to reinforce the styrene end blocks of the block copolymer. Such aromatic resins include coumarone-indene resins, poly alpha methyl styrene, polystyrene resins, vinyl toluene-a-methyl styrene copolymers, polyindene resins. In some embodiments, the tackified elastomer composition includes not more than 10, 9, 8, 7, 6, 5, 4, 3, 2, 1, 0.5, or 0.1 wt % of any of these aromatic resins, except where any of these is part of an aromatic-modified terpene resin. In some embodiments, the adhesive is free of any or more of these aromatic resins. As shown in the Examples, below, the polyphenylene ether resin is unexpectedly more compatible with the mixture of the block copolymer and the terpene resin than another aromatic resin. For example, when a thermoplastic resin made from purified aromatic hydrocarbon monomers, obtained under the trade designation “ENDEX 155” from Synthomer, Kingsport, TN, was used instead polyphenylene ether resin in Control Example C, an extra tan delta peak was observed at 65° C., and there was a significant rise in tan delta above 100° C., which were not observed when a polyphenylene ether resin was used in the tackified elastomer composition in Examples 6, 7, and 9 to 11.

A number of adjuvants may also be useful in the tackified elastomer composition of the adhesive of the present disclosure. Examples of such adjuvants include antioxidants, such as hindered phenols, amines, sulfur and phosphorous hydroperoxide decomposers, and butylated hydroxytoluene (BHT)); inorganic fillers such as talc, zinc oxide, titanium dioxide, aluminum oxide, and silica; and plasticizing aids such as those materials described as plasticizers in the Dictionary of Rubber, K. F. Heinisch, pp. 359, John Wiley & Sons, New York (1974), oils, elastomer oligomers, and waxes. Useful commercially available antioxidants include those available from BASF, Florham Park, NJ, under the trade designations “IRGANOX” and “IRGAFOS” such as “IRGANOX 1010” and “IRGANOX 1520” and those available from Songwon Ind. Co, Ulsan, Korea, under the trade designations “SONGNOX”. Useful plasticizing oils include paraffinic oils, aromatic oils, and naphthene oils such as those available, for example, from Process Oils Inc., Houston, TX. The plasticizing oil may be selected based on viscosity, for example. Compositions according to the present disclosure can also include at least one of pigments, dyes, ultraviolet light absorbers, hindered amine light stabilizers, and heat stabilizers (e.g., sodium benzoate), if desired. When present, typically the antioxidant is present in the tackified elastomer composition in an amount of 0.1 to 5 parts by weight per 100 parts by weight of the block copolymer; typically the ultraviolet light absorber is present in the tackified elastomer composition in an amount of 0.1 to 3 parts by weight per 100 parts by weight of the block copolymer; the inorganic filler can present in the tackified elastomer composition in an amount of up to 50 parts by weight per 100 parts by weight of the block copolymer; and the plasticizing aid is present in the composition in an amount from one to 30, 20, 15, or 10 percent by weight of the total adhesive weight.

The tackified elastomer composition of the adhesive of the present disclosure can also include other thermoplastic materials, for example, ethylene-vinyl acetate, which may be useful for enhancing the spray pattern of the adhesive. When present, ethylene-vinyl acetate may be present in the tackified elastomer composition in an amount of 1 part to 20 parts or 5 parts to 15 parts by weight per 100 parts by weight of the block copolymer.

The adhesive of the present disclosure includes a liquid vehicle, and the tackified elastomer composition is at least one of dissolved or dispersed in the liquid vehicle. The liquid vehicle can include organic solvent, water, or a combination thereof. The amount of liquid vehicle typically varies inversely with the amounts of other components in the adhesive of the present disclosure. Any of the liquid vehicles described herein or any combination of the liquid vehicles described herein may be present in the adhesive in at least 50, 55, 60, 70, 75, 80, 90, or 95 percent by weight, based on the total weight of the adhesive.

In some embodiments, the liquid vehicle comprises a hydrocarbon solvent. Useful hydrocarbon solvents include aromatic hydrocarbon solvents (e.g., toluene and xylene), saturated hydrocarbon solvents having from 5 to 9 or 5 to 8 carbon atoms, and mixtures thereof. Examples of suitable saturated hydrocarbon solvents include n-pentane, isopentane, n-hexane, isohexane, n-heptane, isoheptane, n-octane, isooctane, nonane, cyclopentane, methyl cyclohexane, and cyclohexane. Further examples of useful hydrocarbon solvents include isoparaffinic solvents obtained from Total Fina, Paris, France, under trade designations “ISANE IP 130” and “ISANE IP 175” and from Exxon Mobil Chemicals, Houston, TX, under the trade designation “ISOPAR”. Mixtures of any of these solvents may be useful as the liquid vehicle in the adhesive of the present disclosure.

In some embodiments of the adhesive of the present disclosure, the liquid vehicle comprises at least one of a methylated siloxane, a ketone or ester each having up to six carbon atoms, a halogenated alkane having up to two carbon atoms, tetrachloroethene, 1-chloro-4-trifluoromethyl benzene, or ethane. Certain of these solvents are listed as exempt VOCs in the California Consumer Products Regulations, Subchapter 8.5, Article 2, 94508, amended Sep. 17, 2014 (Register 2014, No. 38) and the California Air Resources Board. A full list of VOC exempt solvents maintained by the US Environmental Protection Agency may be found at epa.gov/ground-level-ozone-pollution/complete-list-voc-exemption-rules. Examples of suitable ketones having up to six carbon atoms include acetone, methyl ethyl ketone, and methyl butyl ketone. Examples of suitable esters having up to six carbon atoms include methyl acetate, ethyl acetate, propyl acetate, and butyl acetate (e.g., n-butyl acetate and t-butyl acetate). In some embodiments, the liquid vehicle is non-fluorinated, in some embodiments, non-halogenated. In some embodiments of the adhesive of the present disclosure, the liquid vehicle comprises at least one of acetone, methyl acetate, methyl formate, or t-butyl acetate. In some embodiments of the adhesive of the present disclosure, the liquid vehicle comprises at least one of acetone, methyl acetate, or t-butyl acetate. In some embodiments, the liquid vehicle comprises at least one of acetone or methyl acetate.

The adhesive can be provided in water or solvent, for example, by dissolving the block copolymer, the terpene resin, and the polyphenylene ether resin as describe above in any of their embodiments in a liquid vehicle (e.g., any of those described above) using standard mixing equipment. The adhesive can be useful as a spray adhesive and/or coated onto a backing or other substrate and drying the coated product or allowing it to dry to remove the liquid vehicle.

In some embodiments, the adhesive of the present disclosure is useful as a spray adhesive. In a spray adhesive, upon or after spraying, the liquid vehicle may evaporate, and the adhesive may develop adhesive properties as the liquid vehicle evaporates. Spray adhesives may function as PSAs or contact adhesives, for example, and the time required before bonding may be adjusted by varying the adhesive formulation, including the liquid vehicle. Solvent-based spray adhesives may require just a few seconds or minutes before bonding and may have a working time of several minutes for adhesive bonds to be made. In some embodiments of the adhesive and process of the present disclosure, including those in which the ratio of the terpene resin to the block copolymer is greater than 1:1 or at least 1.5:1, 1.6:1, 1.7:1, or 1.9:1, the adhesive only has pressure-sensitive adhesive properties (e.g., tack) while at least a portion of the liquid vehicle is present.

In some embodiments, the spray adhesive includes a propellant. Examples of suitable propellants include nitrogen, carbon dioxide, ethane, propane, isobutane, normal butane, dimethyl ether, 1,1-difluoroethane, trans-1,3,3,3-tetrafluoropropene, and mixtures thereof. In some embodiments, the adhesive of the present disclosure is in the form of an aerosol. In aerosols, the propellent typically comprises at least one of propane, isobutane, butane, dimethyl ether, or 1,1-difluoroethane. Typically, liquid aerosol propellants such as propane, butane, and isobutane are added to the adhesive in an amount ranging from about 5% to about 40%, 10% to 30%, 10% to 25%, or 15% to 25% by weight, based on the total weight of the adhesive. Propane suitable as an aerosol propellant is commercially available under the trade designation “A-110” from Technical Propellants, Inc. When gases such as nitrogen and carbon dioxide are used as the propellant, the gas propellant is typically present in an amount ranging up to about 10%, 8%, 6%, 5%, or 2% by weight, based on the total weight of the composition. In some embodiments, the propellant is non-fluorinated, in some embodiments, non-halogenated. In some embodiments, the propellant is propane, isobutane, butane, isopentane, dimethyl ether, or a combination of any two or more of these. For a combination any two of propane, isobutane, butane, isopentane, dimethyl ether, the ratio of the two can be 5:95, 10:90, 15:85, 20:80, 25:75, 30:70, 35:65, 40:60, 45:55, or 50:50.

In some embodiments, the adhesive of the present disclosure includes not more than 40%, 30%, 29%, or 20% by weight, based on the total weight of the adhesive, of nonaromatic, non-halogenated hydrocarbon solvents, propellants, and combinations thereof that are not VOC exempt. The term “hydrocarbon” refers to compounds that have only carbon and hydrogen atoms and includes any of those listed above, which are generally not VOC exempt. In some embodiments, the adhesive of the present disclosure includes at least 0.5%, 1%, 5%, 10%, 15%, or 20% by weight nonaromatic, non-halogenated hydrocarbon solvents, propellants, and combinations thereof that are not VOC exempt, based on the total weight of the adhesive. In some embodiments, the adhesive of the present disclosure includes from 30% to 75% or 50% to 70% by weight, based on the total weight of the adhesive of a VOC-exempt liquid vehicle, including any of those described above. In some embodiments, the VOC-exempt liquid vehicle is not fluorinated. In some embodiments, the VOC-exempt liquid vehicle is not halogenated. In some embodiments, the VOC-exempt liquid does not include siloxane bonds. In some embodiments, the VOC-exempt liquid vehicle comprises at least one of acetone, methyl acetate, methyl formate, or t-butyl acetate.

In some embodiments, the adhesive of the present disclosure and/or useful for practicing the present disclosure is packaged in a spray container. Any of a variety of different spray containers may be useful for delivering the adhesive of the present disclosure and may be useful in the process of using the adhesive or the process for making a bonded article according to the present disclosure.

In some embodiments, the spray container is an aerosol can. Aerosol cans can be obtained from a variety of sources, for example, from Ball Metalpack, Broomfield, Colorado, under the trade designation “Classic Tinplate Can”. Any aerosol actuator, for example, that obtained under the trade designation “Seaquist 802-24-20/0890-20FS” from Aptar, Mukwonago, Wisconsin, with Buna valves obtained under the trade designation “AR-83” from Aptar, may be useful.

In some embodiments, the spray container is an air-assisted spray system. Examples of useful air-assisted spray systems include those obtained under the trade designation “3M Accuspray ONE Spray Gun System with Standard PPS” and “3M Accuspray Paint Spray System with PPS 2.0” from 3M Company, St. Paul, Minnesota. Thus, the spray container may be a disposable cup or cup and disposable liner attached to a spray gun with an atomizing head or nozzle. Spray can be assisted using compressed air, for example, at pressures in a range from 0.13 Megapascals (MPa) to 0.21 MPa.

In other embodiments, an airless spray system may be useful for the adhesive and processes of the present disclosure. Pressure pots such as one-liter capacity pots with pressure rating up to 225 psi (1.24 MPa), obtained, for example, from Apache Stainless Steel Equipment Corporation, Beaver Dam, Wisconsin can be connected to a nylon hose obtained, for example, under the trade designation “3M Cylinder Adhesive Hose” from 3M Company, St. Paul, Minnesota. The hose can be, for example, up to 8, 7, 6, 5, 4, 3, 2, or 1 meter long. A high throughput metallic spray gun obtained, for example, under the trade designations “GunJet” and “H GunJet” from Spray Systems Co., Minnetonka, Minnesota, with a brass spray nozzle obtained, for example, under the trade designations “4001 UniJet”, “6501 UniJet”, “9501 UniJet”, “1100050 UniJet”, and “800050 UniJet” from Spray Systems Co. may conveniently attached to the hose. The canister can be pressurized with dry nitrogen gas or any desirable gas.

The process according to the present disclosure for making a bonded article that includes a first substrate or a second substrate includes spraying the adhesive of the present disclosure on at least one of the first substrate or the second substrate. The process further includes adhering the first substrate and the second substrate together using the adhesive. In some embodiments, the process further comprises evaporating a portion of the liquid vehicle before adhering the first substrate and the second substrate. The present disclosure provides an article that comprises a first substrate and a second substrate bonded together with the adhesive of the present disclosure. The surfaces of the first substrate and the second substrate may be any desired material. In some embodiments, at least one of the surfaces of the first substrate or the surface of the second substrate comprises at least one of metal, glass, a polymer, paper, a painted surface, a nonwoven or woven fabric, a composite, or wood. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic), metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

In some embodiments, at least one of the first substrate or second substrate has a textured surface. Textured surfaces are common in construction. In some embodiments, at least one of the first substrate or second substrate is a fibrous substrate or a foam substrate (e.g., a polymer foam such as polyurethane, EPDM, and polyethylene foam).

Fibrous substrates include woven or nonwoven fabric. The term “nonwoven” refers to a material having a structure of individual fibers or threads that are interlaid but not in an identifiable manner such as in a knitted fabric. Examples of nonwoven webs include spunbond webs, spunlaced webs, needle-punched webs, airlaid webs, meltblown web, and bonded carded webs. Useful nonwovens may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material. Examples of woven fabrics include twill and canvas.

In some embodiments, at least one of the first substrate or the second substrate is a low surface energy substrate. The term “low surface energy substrate” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO). In some embodiments, at least one of the first substrate or the second substrate is a medium surface energy substrate. The term “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, and poly(methyl methacrylate) (PMMA). The surface energy is typically determined from contact angle measurements as described for example in ASTM D7490-08.

The adhesive of the present disclosure can be useful in a variety of applications. The composition of the present disclosure can also be useful for bonding dissimilar materials together. In some of these embodiments, the first substrate comprises a metal, and the second substrate comprises a rubber or plastic. In some embodiments, the first and second substrates are dissimilar plastics. The composition of the present disclosure can also be useful for foam lamination in which either the first or second substrate is a foam (e.g., a polymer foam such as polyurethane, EPDM, and polyethylene foam). The composition of the present disclosure can also be useful for packaging in which either the first or second substrate is a paper (e.g., polymer-coated paper), paperboard, or wood.

In some embodiments, the adhesive of the present disclosure can be useful in a tape and is disposed on a tape backing. Accordingly, in some embodiments, the present disclosure provides a tape comprising the adhesive of the present disclosure as described above in any of its embodiments. As described above, the adhesive of the present disclosure can be coated on a tape backing and dried or allowed to dry to provide the tape. The tape backing can be any polymeric film material, paper, or a polymer-cloth laminate. Polymeric materials suitable for the backing include polyesters (e.g., poly(ethylene terephthalate)); polyolefins (e.g., polyethylene, polypropylene); ethyl cellulose film; cellulose esters (e.g., cellulose acetate, cellulose acetate butyrate, and cellulose propionate); polyvinylidene chloride-vinyl chloride and/or acrylonitrile polymers such as saran; vinyl chloride polymers (e.g., poly(vinyl chloride) and copolymers of vinyl chloride and vinyl acetate); polyfluoroethylenes (e.g., polytetrafluoroethylene and polytrifluorochloroethylene); polyvinyl alcohol; polyamides such as nylon; polystyrenes such as the copolymers of styrene and isobutylene; regenerated cellulose; benzyl cellulose; cellulose nitrate; gelatin; glycol cellulose; flexible acrylate and methacrylates; urea aldehyde films; polyvinyl acetal; and polyvinyl butyral. The adhesive can be present on tape backing in any useful amount, for example, in a range from 20 grams per square meter (gsm) to 150 gsm. Useful amounts of adhesive can be, for example, 20 gsm to 60 gsm, 20 gsm to 40 gsm, or 40 gsm to 60 gsm for paper and polymer film backings. For polymer/cloth laminates, useful amounts of adhesive can be, for example, 80 gsm to 150 gsm.

In some embodiments, the polymer film tape backing of the tape is surface treated before the adhesive is applied. Useful surface treatments include electrical discharge in the presence of a suitable reactive or non-reactive atmosphere (e.g., plasma, glow discharge, corona discharge, dielectric barrier discharge or atmospheric pressure discharge), ultraviolet light exposure, electron beam exposure, flame discharge, and scuffing. The surface treatment can be applied as the polymer film backing is being made or in a separate process. In some embodiments, the tape includes optional low-adhesion backsize. Low-adhesion backsizes are known to one of ordinary skill in the art can be made from a variety of materials (e.g., a silicone, fluorochemical, or carbamate).

In some embodiments, the adhesive is at least partially crosslinked by exposure to radiation, such as electron beam or ultraviolet radiation. Crosslinking may be carried out in-line with a continuous operation or may occur as a separate process. In some embodiments, crosslinking is carried out after the adhesive is disposed on a backing. The degree of crosslinking achieved is a matter of choice and is dependent upon various factors such as the end product desired, the block copolymer used, and the thickness of the adhesive layer. Techniques for achieving crosslinking via exposure to radiation are known to those of skill in the art. Radiation-crosslinking can enhance, for example, the cohesive strength of the adhesive.

### Some Embodiments of the Disclosure

In a first embodiment, the present disclosure provides an adhesive comprising a tackified elastomer composition at least one of dissolved or dispersed in a liquid vehicle, the tackified elastomer composition comprising a block copolymer comprising at least one polystyrene end block, a terpene resin, and a polyphenylene ether resin. In a second embodiment, the present disclosure provides the adhesive of the first embodiment, wherein the block copolymer comprises at least one of a polystyrene-containing diblock copolymer, a polystyrene-containing triblock copolymer, or a polystyrene-containing star block copolymer, wherein the polystyrene-containing diblock copolymer, the polystyrene-containing triblock copolymer, and the polystyrene-containing star block copolymer each independently comprise a block of at least one of polyisoprene, polybutadiene, poly(ethylene/propylene), poly(ethylene/butylene), or polyisobutylene. In a third embodiment, the present disclosure provides the adhesive of the first or second embodiment, wherein the terpene resin comprises an aromatic-modified terpene resin. In a fourth embodiment, the present disclosure provides the adhesive of any one of the first to third embodiments, wherein the terpene resin comprises at least one copolymer of a terpene and a vinyl aromatic monomer. In a fifth embodiment, the present disclosure provides the adhesive of any one of the first to fourth embodiments, wherein the polyphenylene ether resin has a number average molecular weight of from 300 grams per mole to 25,000 grams per mole. In a sixth embodiment, the present disclosure provides the adhesive of any one of the first to fifth embodiments, wherein the polyphenylene ether resin comprises at least one of poly(2,6-dimethyl-1,4-phenylene oxide) or poly(para-phenylene oxide). In a seventh embodiment, the present disclosure provides the adhesive of any one of the first to the sixth embodiments, wherein the block copolymer comprises a diblock copolymer comprising a polystyrene block and a block of at least one of polyisoprene, polybutadiene, poly(ethylene/propylene), or poly(ethylene/butylene). In an eighth embodiment, the present disclosure provides the adhesive of any one of the first to seventh embodiments, wherein the block copolymer comprises a midblock and at least two polystyrene end blocks. In a ninth embodiment, the present disclosure provides the adhesive of any one of the first to eighth embodiments, wherein the block copolymer comprises at least one of a styrene-isoprene-styrene triblock copolymer or a styrene-butadiene-styrene triblock copolymer. In a tenth embodiment, the present disclosure provides the adhesive of any one of the first to ninth embodiments, wherein the tackified elastomer composition further comprises ethylene-vinyl acetate.

In an eleventh embodiment, the present disclosure provides the adhesive of any one of the first to tenth embodiments, wherein the liquid vehicle comprises organic solvent. In a twelfth embodiment, the present disclosure provides the adhesive of any one of the first to eleventh embodiments, wherein the liquid vehicle comprises a hydrocarbon solvent. In a thirteenth embodiment, the present disclosure provides the adhesive of any one of the first to tenth embodiments, wherein the liquid vehicle comprises at least one of a methylated siloxane, a ketone or ester each having up to six carbon atoms, a halogenated alkane having up to two carbon atoms, tetrachloroethene, 1-chloro-4-trifluoromethyl benzene, or ethane. In a fourteenth embodiment, the present disclosure provides the adhesive of any one of the first to thirteenth embodiments, wherein the liquid vehicle comprises at least one of acetone, methyl acetate, methyl formate, or t-butyl acetate. In a fifteenth embodiment, the present disclosure provides the adhesive of any one of the first to fourteenth embodiments, wherein the liquid vehicle comprises at least one of acetone and methyl acetate. In a sixteenth embodiment, the present disclosure provides the adhesive of any one of the first to fifteenth embodiments, wherein the adhesive comprises 30 weight percent to 75 weight percent of a non-halogenated VOC-exempt solvent. In a seventeenth embodiment, the present disclosure provides the adhesive of any one of the first to sixteenth embodiments, wherein the adhesive comprises 30 weight percent to 75 weight percent of acetone, methyl acetate, methyl formate, t-butyl acetate, or a combination thereof, based on the total weight of the adhesive. In an eighteenth embodiment, the present disclosure provides the adhesive of any one of the first to seventeenth embodiments, not more than 40 weight percent by weight of one or more of nonaromatic, non-halogenated hydrocarbon solvents, propellants, and combinations thereof, wherein the nonaromatic, non-halogenated hydrocarbon solvents are not VOC exempt, based on the total weight of the adhesive.

In a nineteenth embodiment, the present disclosure provides the adhesive of any one of the first to eighteenth embodiments, wherein a weight ratio of the terpene resin to the block copolymer is greater than 1:1. In a twentieth embodiment, the present disclosure provides the adhesive of any one of the first to nineteenth embodiments, wherein the weight ratio of the terpene resin to the block copolymer is at least 1.5:1, 1.6:1, 1.7:1, or 1.9:1. In a twenty-first embodiment, the present disclosure provides the adhesive of any one of the first to twentieth embodiments, wherein a weight ratio of the block copolymer to the polyphenylene ether resin is in a range from 3:1 to 25:1. In a twenty-second embodiment, the present disclosure provides the adhesive of any one of the first to twenty-first embodiments, wherein the block copolymer is present in an amount from 20 weight percent to 59 weight percent, the terpene resin is present in an amount from 40 weight percent to 75 weight percent, and the polyphenylene ether resin is present in an amount from 1 weight percent to 20 weight percent, based on the total weight of the tackified elastomer composition. In a twenty-third embodiment, the present disclosure provides the adhesive of any one of the first to twenty-second embodiments, wherein the block copolymer comprises a styrene-butadiene-styrene triblock copolymer and a styrene-isoprene-styrene triblock copolymer in a weight ratio of at least 1:1, 2:1, 3:1, 4:1, 5:1, or 10:1 and up to 25:1, 20:1, 10:1, or 5:1.

In a twenty-fourth embodiment, the present disclosure provides the adhesive of any one of the first to twenty-third embodiments, further comprising a propellent. In a twenty-fifth embodiment, the present disclosure provides the adhesive of the twenty-fourth embodiment, wherein the propellant comprises at least one of nitrogen, carbon dioxide, ethane, propane, isobutane, normal butane, dimethyl ether, 1,1-difluoroethane, or trans-1,3,3,3-tetrafluoropropene. In a twenty-sixth embodiment, the present disclosure provides the adhesive of the twenty-fifth embodiment, wherein the propellant comprises at least one of propane, isobutane, dimethyl ether, or 1,1-difluoroethane. In a twenty-seventh embodiment, the present disclosure provides the adhesive of the twenty-sixth embodiment, wherein the propellant comprises at least one of propane, isobutane, or dimethyl ether. In a twenty-eighth embodiment, the present disclosure provides the adhesive of any one of the first to twenty-fourth or twenty-seventh embodiments, wherein the adhesive is free of fluorinated solvents and fluorinated propellants. In a twenty-ninth embodiment, the present disclosure provides the adhesive of any one of the first to the twenty-eighth embodiments, wherein the adhesive is stable for at least two weeks at 48° C. as determined using a temperature ramp on a rheometer.

In a thirtieth embodiment, the present disclosure provides a process for making a bonded article comprising a first substrate and a second substrate, the process comprising spraying the adhesive of any one of the first to twenty-ninth embodiments on at least one of the first substrate or the second substrate and adhering the first substrate and the second substrate using the adhesive. In a thirty-first embodiment, the present disclosure provides the process of the thirtieth embodiment, further comprising evaporating a portion of the liquid vehicle before adhering the first substrate and the second substrate. In a thirty-second embodiment, the present disclosure provides the use of the adhesive of any one of the first to twenty-ninth embodiments as a spray adhesive. In a thirty-third embodiment, the present disclosure provides the use of the thirty-second embodiment, wherein the tackified elastomer composition further comprises a thermoplastic for enhancing the spray pattern. In a thirty-fourth embodiment, the present disclosure provides the use of the thirty-third embodiment, wherein the thermoplastic is ethylene-vinyl acetate. In a thirty-fifth embodiment, the present disclosure provides the use of the thirty-fourth embodiment, wherein the ethylene-vinyl acetate is present in the tackified elastomer composition in an amount of 1 part to 20 parts or 5 parts to 15 parts by weight per 100 parts by weight of the block copolymer. In a thirty-sixth embodiment, the present disclosure provides the use of the adhesive of any one of the first to twenty-ninth embodiments to make a tape. In a thirty-seventh embodiment, the present disclosure provides the adhesive of any one of the first to twenty-ninth embodiments disposed on a tape backing.

Embodiments of the compositions and methods disclosed herein are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the Examples and the rest of the specification are by weight. The following abbreviations are used in this section: g=gram, mg=milligram, centimeter=cm, mm=millimeter, in.=inch, ft=feet, ° C.=degrees Celsius, ° F.=degrees Fahrenheit, phr=parts per hundred, wt %=weight percent, lb=pound, g=gram, sec=second, oz=ounces, hr=hour, and min.=minutes.

TABLE 1
Materials List

| DESIGNATION | DESCRIPTION |
|---|---|
| Terpene | Aromatic modified terpene polymer, obtained under the trade designation “YS |
| | RESIN TO125”, from Yasuhara, Hiroshima, Japan |
| PPE1 | Polyphenylene ether resin, obtained under the trade designation “NORYL SA90”, |
| | from Sabic, Houston, TX |
| PPE2 | Polyphenylene ether resin, obtained under the trade designation “NORYL SA120”, |
| | from Sabic |
| EVA | Ethylene vinyl acetate copolymer, obtained under the trade designation “ELVAX |
| | 40W”, from DOW, Calgary, Canada |
| SBS1 | Branched triblock copolymer based on styrene and butadiene, with a polystyrene |
| | content of 31%, obtained under the trade designation “KRATON D1184K” from |
| | Kraton, Houston, TX |
| SBS2 | Linear triblock copolymer based on styrene and butadiene with a polystyrene content |
| | of 31%, obtained under the trade designation “KRATON D1101 KT” from Kraton |
| SBS3 | 70/30 Butadiene/styrene thermoplastic copolymer, polymerized in solution and |
| | having a radial structure, obtained under the trade designation “SOLPRENE 411” |
| | from Dynasol, Spring, TX |
| SIS | Linear triblock copolymer based on styrene and isoprene with a polystyrene content |
| | of 15%, obtained under the trade designation “Kraton D 1161P” from Kraton |
| Diblock | Diblock copolymer based on styrene and butadiene with a polystyrene content of |
| | 33%, obtained under the trade designation “KRATON D1118 ET” from Kraton |
| PT | Polyterpene resin, obtained under the trade designation “PICCOLYTE A125”, from |
| | Pinova, Brunswick, GA |
| HC | Hydrocarbon resin, obtained under the trade designation “ENDEX 155”, from |
| | Synthomer, Kingsport, TN |
| UVA | Ultraviolet light absorber (UVA) of the hydroxyphenol benzotriazole class, obtained |
| | under the trade designation “TINUVIN P”, from BASF Florham Park, NJ |
| Stabilizer | Sodium benzoate, obtained under the trade designation “KALAMA SODIUM |
| | BENZOATE, POSDER NF/FCC”, from Emerald Performance Materials, |
| | Vancouver, WA |
| AO1 | High-molecular weight phenolic antioxidant, obtained under the trade designation |
| | “ETHANOX 330”, from SI Group from Schenectady, NY |
| AO2 | Highly effective antioxidant for a variety of elastomers, obtained under the trade |
| | designation “Irganox 565”, from BASF Kaisten Switzerland |
| AO3 | Liquid hindered amine light stabilizer, obtained under the trade designation “Tinuvin |
| | 292”, from BASF Charlotte, NC |
| Cyclohexane | Cyclohexane, obtained from Chevron Phillips, The Woodlands, TX |
| Solvent A | Isoparaffinic hydrocarbon, obtained under the trade designation “ISOPAR L”, from |
| | ExxonMobil, Antwerpen, Belgium. |
| Solvent B | Isoparaffinic hydrocarbon, obtained under the trade designation “ISOPAR M”, from |
| | ExxonMobil |
| n-Pentane | n-Pentane, obtained from Phillips 66, Borger, TX |
| Methyl acetate | Methyl acetate, obtained from Eastman, Kingsport, TN |

### Test Methods

### Rheological Test

Each of Examples 1 to 18 and Control Examples CE A to CE F (about 30 g) was poured or pipetted onto a 6-inch (15.2-cm) wide dual sided release liner (“Core Series” liner, obtained from 3M Company, St. Paul, MN), which was taped down and labeled on a metal plate. The sample was left at room temperature (72° F., 22° C.) for approximately 2 hours, to allow enough evaporation to allow easy transfer to an oven (“MODEL RFD2-13-2E”, from Despatch ITW-EAE, Lakeville, MN). The whole metal plate, with the adhesive and release liner attached, was placed into a 120° F. (49° C.) oven for approximately 24 hours or until all the solvent evaporated and a dry film of adhesive was left.

To help make a uniform film and reduce bubbles in the film, the film was then folded and pressed to a thickness of 0.12 in. (3 mm). The dried film was folded over on itself 4 times, then pressed in a Carver press (Model C, from Carver, Inc., Wabash, IN) at 250° F. (121° C.) down to a thin film using a metal frame mold with the center measuring 2 in.×2 in.×0.6 in. (5.08 cm×5.08 cm×1.5 mm) at 10,000 lbs (4536 kg) and held for 30 seconds. This process was repeated such that the film samples were pressured a total of 3 times in the Carver press, and before each press, each sample was folded over onto itself 4 times. The mold and sample were removed from the Carver press and allowed to cool to room temperature (72° F., 22° C.). The adhesive center was cut from the mold, with release liner still attached for easier handling.

Samples were allowed to rest at room temperature (72° F., 22° C.) for a minimum of 24 hours before measuring rheology. Testing was performed on 8-mm diameter samples using an ARES-G2 rheometer with TRIOS software (available from TA Instruments, New Castle, DE), having 8-mm aluminum disposable parallel plates attached to both upper and lower stainless-steel fixtures. The “Low and High Temperature Ramp” test method setting was used to measure the tan delta (loss modulus/storage modulus or G″/G′, respectively) at 1 Hz frequency over a range of temperatures. The first ramp of the test was started at 50° C. and the temperature was ramped down at 3° C./min until a defined tan delta peak (glass transition temperature (T_{g})) was reached. The second ramp of the test involved ramping the temperature from 50° C. to 150° C., or until tan delta reached above 2 units, at a rate of 3° C./min. Soak times of 180 seconds at 50° C. were used before starting the first and second ramps. The auto strain adjustment was enabled in the TRIOS software procedure file to ensure the material was in the Linear Viscoelastic Region (LVR) during all temperature ramps. Results from both ramps were combined to evaluate tan delta with respect to temperature at 1 Hz frequency. The results are presented in Table 5.

### Preparation of Samples for Overlap Shear (OLS), Peel, and Shear Adhesion Failure Tests

The Example adhesives, below, were applied with a 1-in. (2.54-cm) utility paintbrush (1-in. (2.54-cm) synthetic bristle, obtained from Grainger, Lake Forest, IL), targeting wet coat weights of roughly 5 g/ft² to 7 g/ft² (5.4 mg/cm² to 7.5 mg/cm²). Once the adhesive was applied onto the substrate, the bonds were joined within 5 to 10 min. The samples were rolled together with a 1.75-in. (4.45-cm) wide rubber hand roller and clipped with a binder clip, allowed to dwell for 16 hr to 24 hr, and then tested on a tensile tester (obtained under the trade designation “QTEST_5”, from MTS Systems Corporation, Eden Prairie, MN). Overlap shear samples were made on birch-birch samples, which were 1.0-in.×4.0-in.×0.25-in. (2.54-cm×10.2-cm×0.64-cm) panels obtained from Forest Product Supply, St. Paul, MN. Peel and dead load samples were prepared on cotton duck to cotton duck, which were 1.5-in.×10.0 in (3.81-cm×25.4-cm), Greige Cotton #10, obtained from Canwil Textiles, Auburn, GA).

### Overlap Shear (OLS) and Peel Tests

Overlap shear strength was measured on a tensile tester (“QTEST_5”, from MTS Systems Corporation) with a sample pulled at a rate of 2.0 in. (5.08-cm)/min. The overlap shear strength at break was recorded for birch/birch OLS samples, described above. Peel strength was determined using the same tensile tester with cotton duck to cotton duck peel samples (described above) pulled at 2.0 in. (5.08-cm)/min. for a total length of 4 in. (10.16 cm). Three samples were measured for each test, and the average was taken. Overlap shear strength and peel strength are reported in pound per inch width (PIW). The results are presented in Table 5.

### Shear Adhesion Failure Test (SAFT)

SAFT was performed by placing 1.0-in² (6.45-cm²) area bonded birch-birch OLS samples, as described above, into an oven (“MODEL RFD2-13-2E”, from Despatch ITW-EAE, Lakeville, MN) and hanging a 100-g weight from the bottom of the birch-birch sample. The temperature of the oven was started at 90° F. (32° C.) and increased by 10° F. every ten minutes until bond failure. The temperature at which the bond broke was recorded. Data was collected and recorded as an average of three samples, and the results are presented in Table 5.

### Dead Load Test

Dead load measurements were obtained by placing samples into the same oven described above. The Dead Load Test was conducted on the second half of the peel sample. One side of the cotton duck fabric was secured in the oven and the other side was affixed with a 500-g weight. Depending on the adhesive, the oven was set to a specific temperature and the 500-g weight was hung for 60 minutes. For Examples 1 to 12 and CE A to D, the temperature was 160° F. (71° C.). For Examples 13 to 17, CE E, and CE F, the temperature was 120° F. (49° C.). The sample was removed from the oven and the total distance peeled was measured. The average of three measurements was recorded and presented in Table 5.

### Examples 1 to 5 (EX 1 to 5) and Control Examples (CE) A and B

The amounts of block copolymers, terpene resins, and polyphenylene ether resins used for EX 1 to EX 5 and CE A and CE B are shown in Table 2. EVA (12 phr, 0.92 wt %), UVA (1 phr, 0.08 wt %), Stabilizer (0.5 phr, 0.04 wt %), AO2 (2 phr, 0.15 wt %), AO3 (2 phr, 0.15 wt %), cyclohexane (257 phr), n-pentane (60 phr), and methyl acetate (673 phr) were also used for each of EX 1 to EX 4, and CE A. EVA (12 phr, 0.92 wt %), UVA (1 phr, 0.08 wt %), Stabilizer (0.5 phr, 0.04 wt %), AO1 (2 phr, 0.15 wt %), cyclohexane (257 phr), n-pentane (60 phr), and methyl acetate (673 phr) were also used for CE B and EX 5. All components, a total of 300 g, were added to a metal pint can, and the mixture was placed on a can roller (commercial bottle roller, TDC (Technical Development Corporation) from Huntersville, NC) for 24 to 48 hours.

TABLE 2
Block Copolymer, Terpene Resin, and Polyphenylene
Ether Resins for EX 1 to 5, CE A and B

| | SBS1 | SIS | Terpene | PT | PPE1 | PPE2 | Total^{a} |
|---|---|---|---|---|---|---|---|
| | phr (wt %) | phr (wt %) | phr (wt %) | phr (wt %) | phr (wt %) | phr (wt %) | phr |
| CE A | 80 (6.17) | 20 (1.54) | 190 (14.64) | 0 (0) | 0 (0) | 0 (0) | 1297.5 |
| EX 1 | 80 (6.15) | 20 (1.54) | 190 (14.61) | 0 (0) | 5 (0.38) | 0 (0) | 1302.5 |
| EX 2 | 80 (6.12) | 20 (1.53) | 190 (14.53) | 0 (0) | 10 (0.76) | 0 (0) | 1307.5 |
| EX 3 | 80 (6.07) | 20 (1.52) | 190 (14.42) | 0 (0) | 20 (1.52) | 0 (0) | 1317.5 |
| EX 4 | 80 (6.12) | 20 (1.53) | 190 (14.53) | 0 (0) | 0 (0) | 10 (0.76) | 1307.5 |
| CE B | 80 (6.18) | 20 (1.54) | 0 (0) | 190 (14.67) | 0 (0) | 0 (0) | 1295.5 |
| EX 5 | 80 (6.13) | 20 (1.53) | 0 (0) | 190 (14.55) | 10 (0.77) | 0 (0) | 1305.5 |

^{a}Total of all components.

### Examples 6 to 12 (EX 6 to 12) and Control Examples CE C and CE D

The amounts of block copolymers, terpene resins, polyphenylene ether resins, and hydrocarbon resin used for EX 6 to EX 12, CE C, and CE D are shown in Table 3. In addition, each of EX 6 to EX 11 and CE C included EVA (10 phr, 0.78 wt %), UVA (1 phr, 0.08 wt %), Stabilizer (0.5 phr, 0.04 wt %), AO2 (2 phr, 0.16 wt %), AO3 (2 phr, 0.16 wt %), cyclohexane (245 phr), Solvent A (31 phr), Solvent B (31 phr), and methyl acetate (653 phr). EX 12 and CE D instead also included EVA (10 phr, 0.78 wt %), UVA (1 phr, 0.08 wt %), Stabilizer (0.5 phr, 0.04 wt %), AO1 (2 phr, 0.16 wt %), cyclohexane (245 phr), Solvent A (31 phr), Solvent B (31 phr), and methyl acetate (653 phr). All components, a total of 300 g, were added to a metal pint can, and the mixture was placed on the can roller described in Examples 1 to 5, CE A, and CE B for 24 to 48 hours.

TABLE 3
Block Copolymer, Terpene Resin, and Polyphenylene Ether Resins for EX 6 to 12, CE C and D

| | SBS1 | SIS | Terpene | PT | HC | PPE1 | PPE2 |
|---|---|---|---|---|---|---|---|
| | phr (wt %) | phr (wt %) | phr (wt %) | phr (wt %) | phr (wt %) | phr (wt %) | phr (wt %) |
| CE C | 80 (6.27) | 20 (1.57) | 150 (11.76) | 0 (0) | 50 (3.92) | 0 (0) | 0 (0) |
| EX 6 | 80 (6.27) | 20 (1.57) | 150 (11.76) | 0 (0) | 0 (0) | 50 (3.92) | 0 (0) |
| EX 7 | 80 (6.27) | 20 (1.57) | 150 (11.76) | 0 (0) | 0 (0) | 0 (0) | 50 (3.92) |
| EX 8 | 80 (6.22) | 20 (1.56) | 150 (11.67) | 0 (0) | 0 (0) | 60 (4.67) | 0 (0) |
| EX 9 | 80 (6.27) | 20 (1.57) | 175 (13.72) | 0 (0) | 0 (0) | 25 (1.96) | 0 (0) |
| EX 10 | 80 (6.27) | 20 (1.57) | 175 (13.72) | 0 (0) | 0 (0) | 0 (0) | 25 (1.96) |
| EX 11 | 80 (6.27) | 20 (1.57) | 165 (12.94) | 0 (0) | 0 (0) | 0 (0) | 35 (2.74) |
| CE D | 80 (6.27) | 20 (1.57) | 0 (0) | 150 (11.76) | 50 (3.92) | 0 (0) | 0 (0) |
| EX 12 | 80 (6.27) | 20 (1.57) | 0 (0) | 150 (11.76) | 0 (0) | 50 (3.92) | 0 (0) |

### Examples 13 to 17 (EX 13 to 17) and Control Examples CE E and CE F

The amounts of block copolymers, terpene resins, and polyphenylene ether resins used for EX 13 to EX 17, CE E, and CE F are shown in Table 4. In addition, each of EX 13 to EX 16 and CE E included EVA (10 phr, 1.14 wt %), UVA (1 phr, 0.11 wt p), AO2 (2 phr, 0.16 wt %), AO3 (2 phr, 0.16 wt %), reagent grade acetone (261 phr), cyclohexane (44 phr), Solvent A (36 phr), n-pentane (134 phr), and methyl acetate (87 phr). EX 17 and CE F instead also included EVA (10 phr, 1.14 wt), UVA (1 phr, 0.11 wt %), AO2 (2 phr, 0.16 wt 1), AO3 (2 phr, 0.16 wt %), reagent grade acetone (261 phr), cyclohexane (44 phr), Solvent A (36 phr), n-pentane (134 phr), and methyl acetate (87 phr). All components, a total of 300 g, were added to a metal pint can, and the mixture was placed on the can roller described in Examples 1 to 5, CE A, and CE B for 24 to 48 hours.

TABLE 4
Block Copolymer, Terpene Resin, and Polyphenylene
Ether Resins for EX 13 to 17, CE E and CE F

| | SBS2 | Diblock | Terpene | PT | PPE1 | PPE2 |
|---|---|---|---|---|---|---|
| | phr (wt %) | phr (wt %) | phr (wt %) | phr (wt %) | phr (wt %) | phr (wt %) |
| CE E | 10 (1.14) | 90 (10.26) | 160 (18.24) | 0 (0) | 0 (0) | 0 (0) |
| EX 13 | 10 (1.13) | 90 (10.20) | 160 (18.14) | 0 (0) | 5 (0.57) | 0 (0) |
| EX 14 | 10 (1.13) | 90 (10.15) | 160 (18.04) | 0 (0) | 10 (1.13) | 0 (0) |
| EX 15 | 10 (1.1) | 90 (10.03) | 160 (17.84) | 0 (0) | 20 (2.23) | 0 (0) |
| EX 16 | 10 (1.13) | 90 (10.15) | 160 (18.04) | 0 (0) | 0 (0) | 10 (1.13) |
| CE F | 10 (1.14) | 90 (10.26) | 0 | 160 (18.24) | 0 (0) | 0 (0) |
| EX 17 | 10 (1.13) | 90 (10.15) | 0 | 160 (18.04) | 10 (1.13) | 0 (0) |

### Example 18

SIS (40 phr, 3.95 wt %), Diblock (60 phr, 5.93 wt %), Terpene (235 phr, 23.21 wt %), PPE1 (15 phr, 1.48 wt %), UVA (0.8 phr, 0.08 wt %), AO2 (1.5 phr, 0.15 wt %), AO3 (1.5 phr, 0.15 wt %), reagent grade acetone (30 phr, 2.96 wt %), cyclohexane (280 phr, 27.66 wt %), Solvent A (50 phr, 4.94 wt %), reagent grade isohexane (150 phr, 14.82 wt %), and reagent grade heptane (150 phr, 14.82 wt %), a total of about 300 g, were added to a metal pint can, and the mixture was placed on the can roller described in Examples 1 to 5, CE A, and CE B for 24 to 48 hours.

Examples EX 1 to 18 and CE A to F were subjected to the Rheological, OLS, Peel, SAFT, and Deadload Tests described above, and the results are shown in Table 5, below. Peak height was the height of the tan delta peak at the T_{g}. “Extra peaks” refers to whether there were additional peaks other than the tan delta peak at the T_{g}. For Examples 1 to 5, CE A, and CE B, high temp. tan delta refers to the tan delta at 120° C. For Examples 6 to 18 and CE C to CE F, high temp. tan delta refers to the tan delta at 100° C.

The adhesive film samples made from Examples 2, 6, and 14 for rheological testing were placed in an oven (“MODEL RFD2-13-2E”, from Despatch ITW-EAE) for two weeks at 120° F. (49° C.), the Rheological Test was repeated, and only slight differences were observed in the rheological data, which were within experimental error.

TABLE 5
Results for EX 1 to 17 and CE A to F

| | Tg, | Peak | Extra | high temp. | OLS, | Peel, | SAFT, | Deadload, |
|---|---|---|---|---|---|---|---|---|
| Example | ° C. | Height | peaks | tan delta | PIW | PIW | ° C. | cm |
| CE A | 14.34 | 1.49 | no | 0.63 | 296.4 | 18.2 | 124.8 | 1.91^{a} |
| EX 1 | 18.47 | 1.57 | no | 0.51 | 431.7 | 19.4 | 123.0 | 0.74 |
| EX 2 | 15.99 | 1.56 | no | 0.49 | 438.4 | 19.2 | 128.5 | 0.32 |
| EX 3 | 15.15 | 1.62 | no | 0.46 | 413.0 | 13.4 | 126.7 | 0.37 |
| EX 4 | 11.93 | 1.5 | no | 0.49 | 274.3 | 19.9 | 124.8 | 0.64 |
| CE B | 23.6 | 1.57 | no | 0.35 | 330.9 | 19.0 | 110.0 | 0.50 |
| EX 5 | 25.43 | 1.67 | no | 0.26 | 364.3 | 16.8 | 134.1 | 0.16 |
| CE C | 2.56 | 0.77 | yes | 0.48 | 258.5 | 12.6 | 121.1 | 9.53 |
| EX 6 | 4.94 | 0.87 | no | 0.30 | 335.0 | 17.4 | 135.9 | 0.16 |
| EX 7 | −6.55 | 0.88 | no | 0.28 | 295.2 | 17.0 | 132.2 | 0.21 |
| EX 8 | −4.85 | 0.69 | yes | 0.35 | 400.2 | 14.6 | 143.3 | 0.26 |
| EX 9 | 3.89 | 1.56 | no | 0.25 | 199.4 | 18.8 | 124.8 | 0.95 |
| EX 10 | 0.03 | 1.42 | no | 0.25 | 222.0 | 17.8 | 130.4 | 0.95 |
| EX 11 | 12.98 | 1.21 | no | 0.22 | 306.4 | 23.2 | 132.2 | 0.10 |
| CE D | 9.57 | 1.2 | no | 0.31 | 315.6 | 22.0 | 121.1 | 0.25 |
| EX 12 | 8.54 | 1.07 | no | 0.17 | 237.5 | 16.4 | 139.6 | 0.11 |
| CE E | 8.04 | 2.58 | no | 1.82 | 342.88 | 17.0 | 87.8 | 0.88 |
| EX 13 | 4.66 | 2.56 | no | 1.17 | 338.9 | 17.6 | 93.3 | 0.53 |
| EX 14 | 10.14 | 2.62 | no | 0.74 | 330.6 | 21.3 | 91.5 | 0.37 |
| EX 15 | 6.17 | 2.48 | no | 0.67 | 291.4 | 21.3 | 97.0 | 0.32 |
| EX 16 | 4.99 | 2.47 | no | 0.93 | 238.5 | 19.5 | 93.3 | 0.42 |
| CE F | 16.15 | 3.1 | no | 0.52 | 180.8 | 17.9 | 82.2 | 1.25 |
| EX 17 | 20.69 | 3.18 | no | 0.34 | 180.8 | 17.6 | 102.6 | 0.58 |
| EX 18 | 15.2 | 3.01 | no | 1.05 | 219.3 | 11.9 | 91.5 | NM^{b} |

^{a}Average of two measurements.
^{b}NM = not measured.

### Examples 19 to 23 (EX 19 to 23) and Control Examples (CE) G and H

The components and their amounts used for EX 19 to EX 23 and CE G and CE H are shown in Table 6. All components, a total of 300 g, were added to a metal pint can, and the mixture was placed on the can roller described in Examples 1 to 5, CE A, and CE B for 24 to 48 hours. Examples EX 19 to 23 and CE G and H were subjected to the Rheological Test described above, and the results are shown in Table 6, below. Peak height was the height of the tan delta peak at the T_{g}. “Extra peaks” refers to whether there were additional peaks other than the tan delta peak at the T_{g}.

TABLE 6
Components of EX 19 to 23, CE G and H in wt % and Rheological Data

| | CE G | EX 19 | EX 20 | EX 21 | EX 22 | CE H | EX 23 |
|---|---|---|---|---|---|---|---|
| UVA | 0.0075 | 0.0075 | 0.0075 | 0.0075 | 0.0075 | 0.0075 | 0.0075 |
| EVA | 0.65 | 0.65 | 0.65 | 0.65 | 0.65 | 0.65 | 0.65 |
| Stabilizer | 0.0004 | 0.0004 | 0.0004 | 0.0004 | 0.0004 | 0.0004 | 0.0004 |
| SBS3 | 5.62 | 5.62 | 5.62 | 5.62 | 5.62 | 5.62 | 5.62 |
| SIS | 1.00 | 1.00 | 1.00 | 1.00 | 1.00 | 1.00 | 1.00 |
| AO1 | 0.150 | 0.150 | 0 | 0 | 0 | 0.150 | 0.150 |
| PT | 0 | 0 | 0 | 0 | 0 | 12.5 | 12.5 |
| Terpene | 12.5 | 12.5 | 12.5 | 12.5 | 12.5 | 0 | 0 |
| AO2 | 0.12 | 0.12 | 0.12 | 0.12 | 0.12 | 0 | 0 |
| AO3 | 0.12 | 0.12 | 0.12 | 0.12 | 0.12 | 0 | 0 |
| PPE1 | 0 | 0.33 | 0.66 | 0 | 0 | 0 | 0 |
| PPE2 | 0 | 0 | 0 | 0.66 | 0.99 | 0 | 0.66 |
| Solvent^{a} | 79.8 | 79.4 | 79.3 | 79.3 | 78.9 | 80.0 | 79.3 |
| Tg, ° C. | 15.32 | 11.4 | 12.17 | 14.34 | 14.04 | 5.74 | 11.34 |
| Peak | 1.75 | 1.76 | 1.78 | 1.79 | 1.71 | 1.68 | 1.56 |
| Height | | | | | | | |
| Extra | no | no | no | no | no | no | no |
| Peaks | | | | | | | |
| Tan delta | 0.66 | 0.59 | 0.58 | 0.52 | 0.49 | 0.56 | 0.37 |
| at 120° C. | | | | | | | |

^{a}The solvent was a mixture of VOC-exempt solvent and not more than 40 weight percent of one or more of nonaromatic, non-halogenated hydrocarbon solvents, based on the total weight of the adhesive.

Various modifications and alterations of this disclosure may be made by those skilled the art without departing from the scope and spirit of the disclosure, and it should be understood that this invention is not to be unduly limited to the illustrative embodiments set forth herein.

1. An adhesive comprising a tackified elastomer composition at least one of dissolved or dispersed in a liquid vehicle, the tackified elastomer composition comprising:
a block copolymer comprising at least one polystyrene end block;
a terpene resin; and
a polyphenylene ether resin.

2. The adhesive of claim 1, wherein the block copolymer comprises at least one of a polystyrene-containing diblock copolymer, a polystyrene-containing triblock copolymer, or a polystyrene-containing star block copolymer, wherein the polystyrene-containing diblock copolymer, the polystyrene-containing triblock copolymer, and the polystyrene-containing star block copolymer each independently comprise a block of at least one of polyisoprene, polybutadiene, poly(ethylene/propylene), poly(ethylene/butylene), or polyisobutylene.

3. The adhesive of claim 1, wherein the block copolymer comprises at least one of a styrene-isoprene-styrene triblock copolymer or a styrene-butadiene-styrene triblock copolymer.

4. The adhesive of claim 1, wherein the terpene resin comprises an aromatic-modified terpene resin.

5. The adhesive of claim 1, wherein the terpene resin comprises at least one copolymer of a terpene and a vinyl aromatic monomer.

6. The adhesive of claim 1, wherein the liquid vehicle comprises organic solvent.

7. The adhesive of claim 1, wherein the liquid vehicle comprises at least one of a hydrocarbon solvent, acetone, methyl acetate, methyl formate, or t-butyl acetate.

8. The adhesive of claim 1, wherein the adhesive comprises 30 weight percent to 75 weight percent of acetone, methyl acetate, methyl formate, t-butyl acetate, or a combination thereof and not more than 40 weight percent by weight of one or more of nonaromatic, non-halogenated hydrocarbon solvents, propellants, and combinations thereof, based on the total weight of the adhesive.

9. The adhesive of claim 1, wherein a weight ratio of the terpene resin to the block copolymer is greater than 1:1.

10. The adhesive of claim 1, wherein the weight ratio of the terpene resin to the block copolymer is at least 1.5:1.

11. The adhesive of claim 1, wherein a weight ratio of the block copolymer to the polyphenylene ether resin is in a range from 3:1 to 25:1.

12. The adhesive of claim 1, further comprising a propellent.

13. The adhesive of claim 1, wherein the adhesive is stable for at least two weeks at 48° C. as determined using a temperature ramp on a rheometer.

14. A process of making a bonded article comprising a first substrate and a second substrate, the method comprising:
spraying the adhesive of claim 1 on at least one of the first substrate or the second substrate; and
adhering the first substrate and the second substrate using the adhesive.

15. (canceled)

16. The process of claim 14, further comprising evaporating a portion of the liquid vehicle before adhering the first substrate and the second substrate.

17. The process of claim 14, wherein the tackified elastomer composition further comprises a thermoplastic for enhancing the spray pattern, wherein the thermoplastic is ethylene-vinyl acetate.

18. The adhesive of claim 1, wherein the polyphenylene ether resin comprises at least one of poly(2,6-dimethyl-1,4-phenylene oxide) or poly(para-phenylene oxide).

19. The adhesive of claim 1, wherein the tackified elastomer composition further comprises ethylene-vinyl acetate.

20. The adhesive of claim 1, wherein the block copolymer is present in an amount from 20 weight percent to 59 weight percent, the terpene resin is present in an amount from 40 weight percent to 75 weight percent, and the polyphenylene ether resin is present in an amount from 1 weight percent to 20 weight percent, based on the total weight of the tackified elastomer composition.

21. The adhesive of claim 1, wherein the block copolymer comprises a styrene-butadiene-styrene triblock copolymer and a styrene-isoprene-styrene triblock copolymer in a weight ratio of at least 1:1.
